(19) United States
(12) Patent Application Publication
(10) Pub. No.: US 2005/0029233 A1
(43) Pub. Date: Feb. 10, 2005

(54) Device for point soldering at least two components

(76) Inventor: Friedrich Wilhelm Schuhen, Steinebach/Sieg (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/399,891

(22) PCT Filed: Oct. 23, 2001
(86) PCT No.: PCT/EP01/12206

(30) Foreign Application Priority Data
Oct. 23, 2000 (DE) 100-52-509.1

(51) Int. Cl. B23K 11/10

(52) U.S. Cl. 219/86.22; 219/86.25

(57) ABSTRACT

The invention relates to a device (1) for spot welding at least two components (2, 3). The device comprises at least two electrode holders (5, 6) which can move in relation to each other and are used to hold a pair of welding electrodes (9, 10). The electrodes are brought into contact with the components (2, 3) during the welding process. The two electrode holders (5, 6) form part of a clamping element (4) and respectively comprise a pressure element (1 1, 12) which transfers a compression force to the area surrounding the welding position during the clamping of the components(2, 3). The welding electrodes (9, 10) can be moved in relation to the pressure elements (11, 12) by means of the advancing mechanism (15).

The invention relates to a device for spot welding of at least two components. Furthermore, the invention refers to a system and a process for spot welding at least two components.

Generic devices are known from the EP 0 640 428 A1 and the DE 43 23 148 A1.

Also, the general state of the art recognizes other such devices, systems and processes.

In these, two components to be welded together, for example auto body panels or such, are held together on their outer edges by a clamping device which often consists of several clamping elements, in order to achieve the alignment and fixation of the components against each other. Finally, a welding gun is led along the edges of the components and welding spots are set at predetermined points. The welding gun can be guided with the help of a manipulator robot, for example, which was previously programmed with the necessary component data.

However, all of the known devices and the accompanying processes for welding of at least two components are disadvantageous in that, often the clamping elements must be loosened in order to set welding spots at particular points which otherwise cannot be reached. Furthermore, in principal, the devices have a very complicated construction, whereby the corresponding processes cost time and money, and therefore the expenditures for joining two components by spot welding are very high. This is particularly true when a highly accurate joining of two components is desired.

The U.S. Pat. No. 3,632,958 describes an electrode holder for welding systems which contains a spring-loaded electrode.

An electric resistance welding device is known from the DE 33 06 420 C1. Here, a piston is pre-tensioned by an hydraulic medium, followed by a weld, and then a decrease of the hydraulic pressure.

The object of the invention being presented, is to create a device and the accompanying system and processes for spot welding of at least two components, by which the at least two components can be spot welded together in as short a time as possible, with the lowest costs and time for construction as possible, and nevertheless with reliable processes and few deviations.

This object is achieved by the features of claim 1.

A system for spot welding at least two components results from the features of claim 10.

A system for spot welding at least two components is given in claim 15.

With the device according to the invention it is possible, before setting the first welding spot, to fill ahead all of the geometric points necessary for welding later and then, simultaneous to clamping the component, to set all of the weld spots in one work step. This possible combination of two work steps otherwise independent of one another brings considerable savings with it in respect to timing, since in a corresponding system with several devices, the spot welds do not follow one another but are set at the same time and therefore, depending on the size of the component, a considerably faster operation is possible. Of course this shortening of the timing has an effect on the manufacturing costs of the work piece in question, so that any higher device costs can be compensated without a problem.

Since, in accordance with the invention, all weld spots are set simultaneously, the clamps do not have to be removed from the component until after the welding process, so that a slipping of the components is not possible and a consistent quality results.

This is made possible because both electrode holders each have a pressure element and are part of the clamping element. Here it is only necessary that the welding electrodes be mobile, in comparison with the pressure elements, and thus can be advanced during the welding process.

The form of the components to be welded together does hardly matter, since several invention-appropriate devices can be added to an entire system without a problem, and in this way it is possible to fill the most important points where spot welds are to be set.

A great advantage of the process according to the invention is the fact that the two components to be welded together are heated simultaneously and, therefore, problems in respect to a possible distortion are excluded from the very beginning. Since each welding mechanism with the accompanying pair of welding electrodes is responsible for producing only one spot weld, only a small measure of heating-up is noted in this respect and, therefore, only a relatively small measure of cooling is necessary as well.

The advancing mechanism according to the invention, which is integrated in every clamping element or every welding apparatus, ensures the proper advancing of the welding electrodes and, as an advantage, can be individually adapted to every weld spot to be produced in regard to the advancing force or the speed.

In an advantageous embodiment of the invention, the advancing mechanism can contain at least two spring elements for applying pressure to both welding electrodes, one spring element being assigned to each welding electrode. This represents a simply designed embodiment of the advancing mechanism, in which the spring elements are adapted to the respective requirements of the components to be welded or to the welding electrodes used.

Alternatively, the advancing mechanism can contain a medium for applying pressure to both welding electrodes for advancing the same. High pressures can be realized through this medium and be applied to the welding electrodes in a simple manner.

Finally, it is also possible that the advancing mechanism could contain an servo motor, which is planned for advancing the welding electrodes and which can be run using the corresponding controls.

Further advantageous embodiments of the invention arise from the other dependent claims and from the following basic design example shown with help of the drawing, in which:

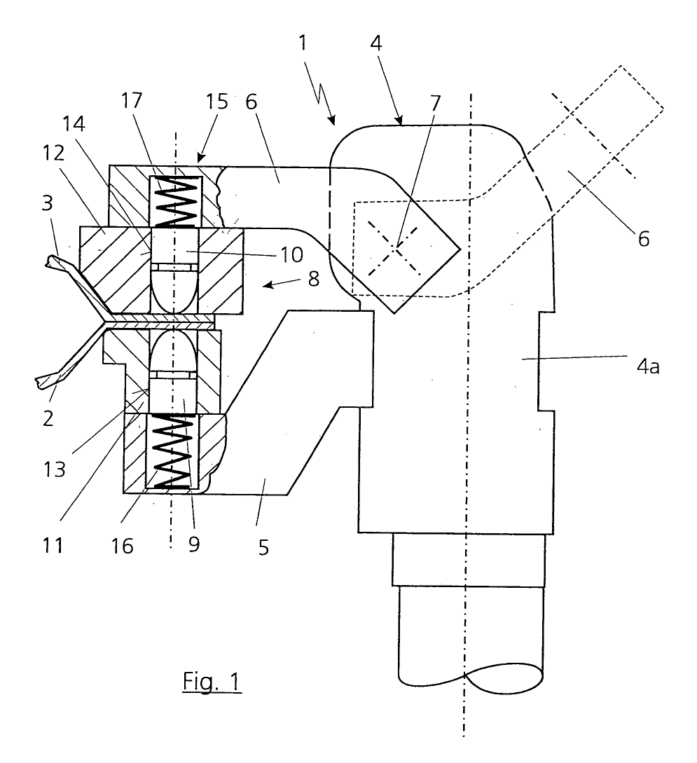

FIG. 1 shows a side view of the invented device for spot welding at least two components;

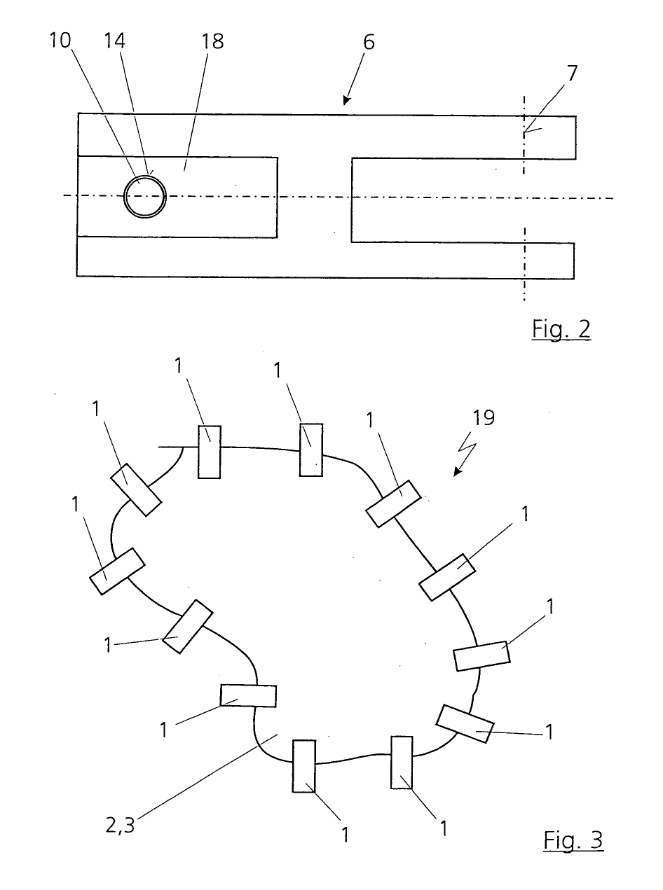

FIG. 2 shows a view from above of an arm of the clamping element from FIG. 1;

FIG. 3 shows several devices forming a system for spot welding at least two components from FIG. 1;

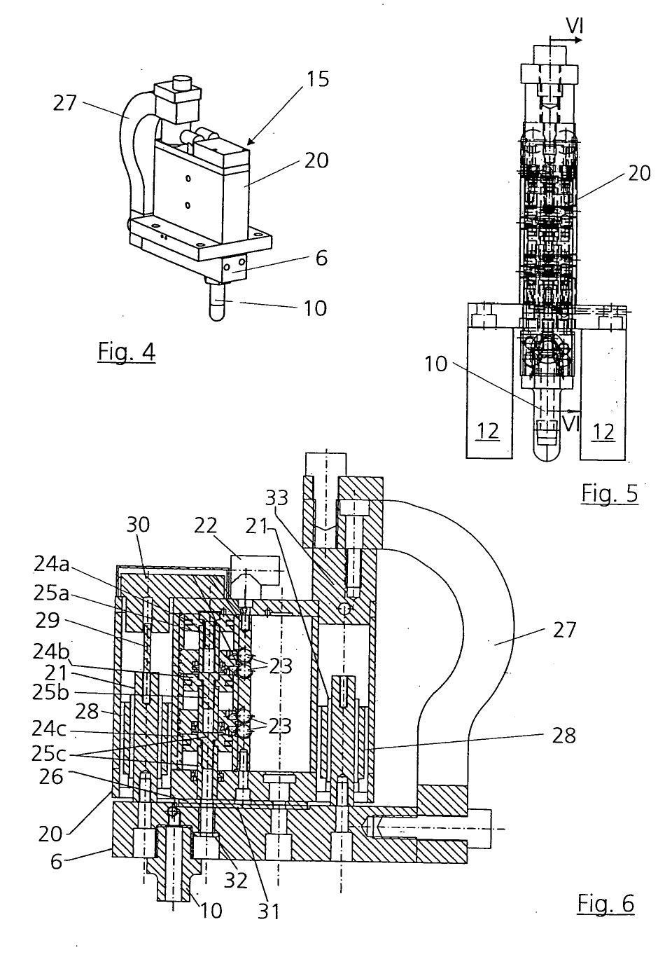

FIG. 4 shows a perspective representation of a advancing mechanism for the invented device;

FIG. 5 shows a front view of the advancing mechanism from FIG. 4; and

FIG. 6 shows a section of the advancing mechanism according to the Line VI-VI from FIG. 5.

FIG. 1 shows a device 1 for welding two components 2 and 3. In this case, both components 2 and 3 are auto body panels, but of course other types and numbers of components can be welded together by the device 1.

The device 1 contains a clamping element 4 with a body 4a, which is intended for clamping components 2 and 3, and for this purpose contains two arms or electrode holders 5 and 6. The electrode holders 5, 6 can be moved together, whereby the bottom electrode holder 5 turned towards component 2 is rigid, and the upper electrode holder 6 turned towards component 3, is mobile around a pivot point 7 in comparison with the body 4a. Hereto, the clamping element 4 contains a hydraulic or pneumatic clamping cylinder not depicted, which is able to move the electrode holder 6 around the pivot point 7. In FIG. 1 the closed state of the clamping element 4 is shown, the open position of the electrode holder 6 being indicated by interrupted lines. In principal, the clamping element 4 can be realized as a C-gripper or an X-gripper.

A welding apparatus 8 is attached to the clamping element 4, which contains two welding electrodes 9 and 10 that work together. Both welding electrodes 9 and 10 are thus arranged on the clamping element 4, namely within each of the pressure elements 11 and 12, which, when clamping components 2 and 3, come into contact with the same and press them together. The pressure elements 11 and 12 thus offer a pressure surface for the electrode forces required for welding.

The pressure element 11 is attached to the electrode holder 5 and thereby comes into contact with component 2, whereas the pressure element 12 is arranged on electrode holder 6 and comes into contact with component 3. In order to be able to accommodate the welding electrodes 9 and 10, the pressure elements 11 and 12 each contain recesses 13 and 14, in which the welding electrodes 9 and 10, respectively, are axially adjustable arranged. The welding electrodes 9 and 10 are each connected to a lead element for the supply of electricity, not depicted, which are arranged on the sides of the pressure elements 11 and 12 that are turned away from the components 2 and 3.

If components 2 and 3 are now supposed to be spot welded together by the device 1, first the electrode holder 6 is brought into the shown position with the help of the clamping cylinder, which clamps the components 2 and 3 tightly together. During the same work step, the two welding electrodes 9 and 10 are placed on the components 2 and 3 and the accompanying lead element is supplied with voltage, whereby components 2 and 3 normally begin to melt or become doughy in the area of the two welding electrodes 9 and 10.

In order to make advancing of the welding electrodes 9 and 10 possible during this welding process, a advancing mechanism 15 is planned which contains two spring elements 16 and 17 in the shown embodiment. The spring element 16 assigned to the welding electrode 9 and applies pressure to the same. The same holds true for spring element 17, which is assigned to the welding electrode 10. Both spring elements 16 and 17 contain such a spring constant, that the welding electrodes 9 and 10, when melting the material of components 2 and 3, are advanced automatically and consequently a spot weld is performed. Both of the welding electrodes 9 and 10 are supplied with voltage for a time span of 20 to 30 ms, preferably 25 to 28 ms, and are in contact for that long with the two components 2 and 3.

Furthermore, the advancing mechanism ensures that the pressure necessary for welding is applied to both welding electrodes 9 and 10. In principal, when welding, the welding electrodes 9 and 10 are advanced or set back about 1-5 mm depending on the thickness and the material of the components 2 and 3 as well as on the strength of the applied current.

Alternatively to the two spring elements 16 and 17, the advancing mechanism 15 could contain a medium, in a way that is not depicted, for applying pressure to the two welding electrodes 9 and 10. Here a liquid medium would be particularly suitable, which could be used simultaneously to cool the welding electrodes 9 and 10. Such a cooling, however, is not shown in the figures.

Alternatively, servo motors are also be possible, which could form the advancing mechanism 15 and in turn, to whom the welding electrodes 9 and 10 would be assigned as a drive. If the material of components 2 and 3 is very thick, the advancing mechanism 15 can contain additional elements if necessary, in order to apply a correspondingly high pressure.

In FIG. 2 a view of the upper electrode holder 6 of the clamping element 4 is depicted, in which the pressure element 4 with the recess 14 inside for accommodating the welding electrode 10 can be discerned. The electrode holder 6 contains a welding surface or copper surface 18, which is connected to the lead element, in a non-depicted way. The same applies analogous to the welding electrode 9, which is not depicted in this Figure.

In a very schematic representation, FIG. 3 shows the entire system 19 for spot welding the two components 2 and 3, which contain several suitably arranged devices 1 according to FIGS. 1 and 2. Both components 2 and 3 can be inserted into the system 19, whereupon the device 1 welds the two described above together.

Moreover, the devices 1 can be arranged rigidly in order to form a system 19 with a certain contour for components 2 and 3. Alternatively, the devices 1 can also be ones that travel, thereby forming a flexible system 19 for the spot welding of components 2 and 3. The, at least one, clamping element 4 of the device 1 can be closed either automatically, i.e. with a clamping cylinder as described previously above, or also manually. With devices 1 which can be closed manually, first all present devices 1 are closed, and then the welding on all the spots is performed.

The described device 1 can also be used for pure welding of the components 2 and 3, whereby the pressure elements 11 and 12 can be dispensed with.

FIG. 4 shows a further embodiment of the advancing mechanism 15 which also serves to apply pressure to the two electrode holders 5 and 6 or to the two welding electrodes 9 and 10.

Therefore, the advancing mechanism 15 could also be seen as a mechanism for applying pressure to each of the electrode holders 5 and 6.

In FIG. 5 another arrangement of the welding electrode 10 in comparison with the pressure element 12 is depicted. According to this, the pressure element 12 consists of two individual elements, between which the welding electrode 10 is arranged.

As can be seen clearly in the section represented in FIG. 6, the advancing mechanism contains a housing 20, on which in this case the mobile upper electrode holder 6 is stored above two guide elements 21. Of course the lower electrode holder 5 can also be equipped with an appropriately formed advancing mechanism 15, which is not depicted here.

A supply line 22 is attached to the housing 20, through which, for example, pressurized air can reach the interior of the housing. The advancing device 15 functions therefore pneumatically, but could also work hydraulically or electrically, for example with appropriate motors. Through several distribution bores 23 the pressurized air works on several pistons 24a, 24b and 24c switched one after the other, which move the electrode holder 6 away from the advancing mechanism 15 by means of several piston rods 25a, 25b and 25c attached between the respective pistons 24a, 24b and 24c. A hard-wearing spring washer 26 is arranged between the lowest piston rod 25c and the electrode 6.

In addition a current supply 27 for the electrode holder 6 is arranged on the housing, which, however, can be of a known type.

The two guide elements 21 are each electrically insulated from the housing 20 by means of insulating sleeves 28. In addition, a transmitter 29 is attached to one of the guide elements 21, which cooperates with a path measurement system 30 in order to be able to determine the exact position of the electrode holder 6. The spring washer 26, the lower piston rod 25c and the current supply 27 are also equipped with insulating elements 31, 32 and 33, in order to electrically insulate the housing 20 from the electrode holder 6.

1-17. (canceled)

18. A device for spot welding at least two components comprising:
at least two electrode holders which move together to hold a pair of welding electrodes, which are brought into contact with the components when welding; and
an advancing mechanism for advancing the welding electrodes during the welding process;
the two electrode holders are parts of a clamping element and each contain a pressing element, which, when clamping the components transfers a pressing force to an area around the welding position,
the welding electrodes can be moved by means of an advancing mechanism in comparison with the pressing elements,
each pressure element having a recess in which the two welding electrodes are arranged,
one of the electrode holders is rigid at least during clamping and welding.

19. The device according to claim 18, wherein the advancing mechanism contains at least two spring elements for applying pressure to the two welding electrodes, one spring element being assigned to each welding electrode.

20. The device according to claim 19, wherein the spring elements have such a spring constant, that when melting the material of the, at least, two components, the welding electrodes are automatically advanced.

21. The device according to claim 18, wherein the advancing mechanism contains a medium for applying pressure to both welding electrodes for advancing of the same.

22. The device according to claim 21, wherein the medium is a liquid medium, which can be used simultaneously to cool the welding electrodes.

23. The device according to claim 18, wherein the advancing mechanism contains servo motors assigned to the welding electrodes.

24. The device according to claim 18, wherein at least one clamping element contains an hydraulic or pneumatic clamping cylinder, by means of which at least one of the electrode holders is mobile.

25. The device according to claim 18, wherein the two welding electrodes are each connected to a lead element for the supply of electrical current, each of which is arranged on the side of the pressure elements that is turned away from the welding electrodes.

26. A system comprising a device for spot welding at least two components, the device comprising;
at least two electrode holders which move together to hold a pair of welding electrodes, which are brought into contact with the components when welding; and
an advancing mechanism for advancing the welding electrodes during the welding process;
the two electrode holders are parts of a clamping element and each contain a pressing element, which, when clamping the components transfers a pressing force to an area around the welding position,
the welding electrodes can be moved by means of an advancing mechanism in comparison with the pressing elements,
each pressure element having a recess in which the two welding electrodes are arranged,
one of the electrode holders is rigid at least during clamping and welding.

27. The system according to claim 26, wherein the at least one device is arranged rigidly.

28. The system according to claim 26, wherein the at least one device can travel.

29. The system according to claim 26, wherein the at least one clamping element of the at least one device can be closed automatically.

30. The system according to claim 26, wherein the at least one clamping element of the at least one device can be closed manually.
